(19) United States
(12) Patent Application Publication
(10) Pub. No.: US 2012/0328685 A1
(43) Pub. Date: Dec. 27, 2012

(54) SYSTEM FOR PROTECTING GOODS DURING TRANSPORT

(75) Inventors: Susanne Stutz, Weinheim (DE); Claus Kaiser, Frankenthal (DE); Jürgen Weiser, Schriesheim (DE); Daniel Bihlmeyer, Apex, NC (US); Stefan Schaffert, Bensheim (DE)

(73) Assignee: BASF SE, Ludwigshafen (DE)

(21) Appl. No.: 13/534,781

(22) Filed: Jun. 27, 2012

Related U.S. Application Data
(60) Provisional application No. 61/501,328, filed on Jun. 27, 2011.

(51) Int. Cl. B65D 81/28; A01P 15/00; B67C 3/22; A01N 25/34

(52) U.S. Cl. 424/412; 426/326; 53/428

(57) ABSTRACT

A system for protecting stored goods in a container (10), comprises a cage-like structure (20) formed by at least one pesticide treated net (22), capable of enclosing the stored goods, wherein the cage like structure (20), further comprises means for suspending the pesticide treated nets (14, 28, 30, 32, 34), and means for opening and closing the cage-like structure (26) on at least one section (24) of the at least one net (22). The system is particularly useful for the transport of tobacco, coffee, dried fruits, cocoa, nuts, tea, cereals, vegetables, spices and animals.

### CROSS-REFERENCE TO RELATED APPLICATIONS

This application claims benefit, under 35 U.S.C. §119(e), to U.S. Provisional Application No. 61/501,328, filed Jun. 27, 2011, which is incorporated herein by reference in its entirety.

### BACKGROUND

1. Field of the Invention

The invention relates to a system for protecting goods in a transport container from pests and to a method for protecting stored goods in a transport container from pests by applying the system.

2. Description of Related Art

Many food, tobacco and other products of natural origin need to be transported over long distances before they are delivered to retailers and consumers. During this time these products are prone to infestation by various pests. E.g., every year, tobacco at a cost of 400 million US dollars is lost to pest infestation. Over 500 million US dollars in stored cocoa and coffee—4% and 5%, respectively—is also lost to pests on an annual basis.

Accordingly, it is a continuous challenge to minimize losses of food and other products to pests during transport.

Currently mainly fumigation, heating and freezing procedures are used to control pests in transport containers. However, every fumigation requires sealing of the containers. In addition, most fumigants are highly toxic for humans. Thus, if not properly handled, they pose a potential health hazard for the workers engaged. In addition, residues of the fumigant in the stored products must be avoided.

Alternatives to the presently practiced methods are, therefore, highly desirable. WO 2007/144401 discloses a method for protecting tobacco from harmful organisms during storage by covering the tobacco with a net that has a protective activity against the harmful organism.

WO 2008/052913 discloses a method for protecting crop plants from harmful organisms, comprising the step of covering one or more of the plants with a device, comprising a stabilizing structure and a meshed fabric, where the meshed fabric is impregnated with a pesticide and is penetrable by light, air and water.

However, neither of these documents is directed to the specific needs of protecting goods in modern global transport and logistics. In order to be feasible in such an environment a system for protecting goods must fulfill various requirements such as:
avoidance of health hazards to the workers, and pesticide residues in the stored goods,
flexibility to adapt the system to different types of transport containers,
ease of installation and use,
physical stability,
ease and safety of handling in operation.

### BRIEF DESCRIPTION OF THE DRAWINGS

FIG. 1 shows a container with the system installed in a perspective view,

FIG. 2 shows a container with the system installed from the front,

FIG. 3a and b show a further embodiment of the system installed in a container.

### DETAILED DESCRIPTION OF THE INVENTION

It has now been found that the above requirements can be met by a system for protecting stored goods in a transport container, in which the walls of a transport container are lined by pesticide treated nets, capable of enclosing the stored goods.

Accordingly, in one aspect of the invention there is provided a system for protecting stored goods in a container, comprising a cage-like structure formed by at least one pesticide treated net, capable of enclosing the stored goods, wherein the cage-like structure further comprises

means for suspending the at least one pesticide treated net,

and means for opening and closing the cage-like structure on at least one section of the at least one net.

In a further aspect of the invention there is provided a method for protecting goods during transport, comprising the steps of installing the cage-like structure in a container and placing the goods inside the cage-like structure.

The system of the invention provides several advantages such as
avoidance of health hazards to the workers, and pesticide residues in the transported goods,
flexibility to adapt the system to different types of containers,
ease of installation and use,
physical stability,
ease and safety of handling in operation.

The system can be adapted to containers of any size by changing the size of the cage like structure. Typical sizes of an ISO container vary from 6,058 meters length, 2,438 meters width and 2,591 meters height to 13,716 meters lengths, 2.438 meters width and 2,896 meters height.

The system can also be adapted to protect goods transported by trucks or any other transport means where the goods are transported inside an enclosed area. The term “container” as used herein also encompass the loading area of a vehicle such as a truck. The cage-like structure can be adapted to any shape required to protect the stored goods.

The term “wall” as used herein encompasses the walls, ceiling and floor of a container or any other enclosed area used for the transportation of goods. This means that the pesticide treated nets enclose the goods to be protected on all sides.

Pests must not be allowed to enter the area protected by the cage-like structure.

In a preferred embodiment of the invention, the cage-like structure is formed by a single three dimensional net. Thus gaps between the sides, the top and/or the bottom of the structure are avoided.

The adaptability of the system is achieved by providing means to fasten the pesticide treated nets to at least two walls and/or the ceiling of the container, comprising straps, cable ties, rings, hooks, clamps, cables/ropes/chains, rubber bands and/or grommets.

The standard ISO containers provide suitable receptacles to fasten liner bags used in the transport of bulk material. These means are also suitable receptacles for the above means to fasten the pesticide treated nets. If the cage like structure is to be installed in an area where no suitable receptacles are provided, the cage like structure is mounted by fixing a support frame on at least two walls and/or on the ceiling of the enclosed area. The support frame can be mounted using suitable fastening elements which are known to the expert and include for example bolts, screws, nuts, clamps and brackets.

In the daily loading routine forklifts are used. In a preferred embodiment of the invention the nets are arranged such that the nets are capable of bearing a forklift. The means for opening and closing the cage like structure are arranged such that a clear opening in the front side of approximately rectangular shape is formed which does not hinder access by a forklift.

In another embedment of the invention the means for opening and closing the cage like structure are arranged such that the front section of the cage like structure can be completely removed.

In one embodiment of the invention the means to fasten the pesticide treated nets are provided with breaking pints in order to release the nets if a maximum load is exceeded.

One important aspect of the invention is the ease of use of the system in the daily routine of transport. The system must allow for easy placement and removal of the protected goods. This is achieved by providing the cage-like structure with at least one section which can be opened by removing a section of the net, lifting a section of the net or drawing a section of the net aside.

The cage-like structure can be provided with means to manually open/close the at least one section of the at least one net. These means comprise zippers, Velcro strips, adhesives, cables/ropes/chains, straps and/or rubber bands.

In one embodiment of the invention, the net or part of the net covering the top of the cage like structure comprises ropes to reduce the sagging of the net.

One important aspect of the invention is to reduce the amount of pesticides required to control the pest levels, especially to avoid fumigation of the container. This is achieved by effectively hindering insects and pests to enter the protected storage space inside the system. Thus it is of great importance that the container and the stored goods are initially pest free.

Further it may be useful to monitor the pest levels in the container and inside the storage constructions in order to assess the effectiveness of the system.

Thus in a preferred embodiment of the system the system further comprises means to monitor pest infections. These means comprise pheromone traps arranged in the protected area near the stored goods and/or outside the storage constructions.

In a further aspect of the invention there is provided a method for protecting goods during transport in a container, comprising the steps of installing a system according to the invention in the container and placing the goods inside the cage-like structure.

In a preferred embodiment of the invention, the net on at least one section of the cage-like structure is provided with means for opening and closing the cage-like structure and the cage-like structure is opened before moving/removing goods into or out of the cage-like structure and closed afterwards.

In a preferred embodiment of the invention, the goods are treated against pests before placing the goods inside the cage-like structure. The treatment against pests can comprise fumigation.

In another preferred embodiment the pest levels inside the cage-like structure are monitored. The levels are tracked over time such that the efficacy of the system against pests can be assessed. If the pest levels rise and/or after the nets have been in use for a certain predetermined amount of time the pesticide treated nets should be replaced.

Further, if the means to monitor pest levels indicate that the transported goods are delivered free of pests, an otherwise required fumigation of the goods can be omitted.

It is preferred that used nets forming the cage-like structure are returned to the manufacturer for disposal.

The nets employed according to the invention are impregnated with one or more pesticides. In general, the pesticide is incorporated into the material (e.g. into the plastics matrix) or applied to the surface of the material or both.

In a preferred embodiment, the material is treated with a composition comprising:

a) at least one pesticide (component A), and

b) at least one polymeric binder (component B).

Such compositions are disclosed, e.g., in WO 2007/144401.

The term “pesticide” as used herein comprises insecticides, repellents and fungicides.

The term “insecticides” as used herein comprises agents with arthropodicidal (specifically, insecticidal, acaricidal and miticidal), molluscicidal and rodenticidal activity, if not otherwise stated in the context.

The term “fungicides” as used herein comprises agents with fungicidal, microbicidal and viricidal activity, if not otherwise stated in the context.

Preferably, the pesticide is an insecticide or repellent.

Pesticide (component A)

Preferably, the pesticide is an insecticide and/or repellent with a fast paralyzing or killing effect of the insect and low mammalian toxicity. Suitable insecticides and/or repellents are known by a person skilled in the art. Suitable insecticides and repellents are disclosed e.g. in E. C. Tomlin et al, The Pesticide Manual, 13 ed., The British Crop Protection Council, Farnham 2003, and the literature cited therein.

Preferred insecticides and/or repellents are mentioned below: pyrethroid compounds such as

Etofenprox: 2-(4-ethoxyphenyl)-2-methylpropyl-3-phenoxybenzyl ether,

Chlorfenapyr: 4-bromo-2-(4-chlorophenyl)-1-ethoxymethyl-5-(trifluoromethyl)pyrrole-3-carbonitrile,

Fenvalerate: (RS)-alpha-cyano-3-phenoxybenzyl(RS)-2-(4-chlorophenyl)-3 methyl-butyrate,

Esfenvalerate: (S)-alpha-cyano-3-phenoxybenzyl(S)-2-(4-chlorophenyl)-3-methylbuty-rate,

Fenpropathrin: (RS)-alpha-cyano-3-phenoxybenzyl 2,2,3,3-tetramethylcyclopropane-carboxylate,

Cypermethrin: (RS)-alpha-cyano-3-phenoxybenzyl(1RS)-cis, trans-3-(2,2-dichloro-vinyl)-2,2-dimethylcyclopropanecarboxylate,

alpha-Cypermethrin: racemate comprising the (S)-α-(1R) and (R)-α-(1S) diastereomers,

Permethrin: 3-phenoxybenzyl(1RS)-cis, trans-3-(2,2-dichlorovinyl)-2,2-dimethylcyclo-propanecarboxylate,

Cyhalothrin: (RS)-alpha-cyano-3-phenoxybenzyl(Z)-(1RS)-cis-3-(2-chloro-3,3,3-trifluoroprop-1-enyl)-2,2-dimethylcyclopro panecarboxylate, lambda-cyhalothrin,

Deltamethrin: (S)-alpha-cyano-3-phenoxybenzyl(1R)-cis-3-(2,2-dibromovinyl)-2,2-dimethylcyclopropanecarboxylate,

Cycloprothrin: (RS)-alpha-cyano-3-phenoxybenzyl(RS)-2,2-dichloro-1-(4-ethoxy-phenyl)cyclopropanecarboxylate,

Fluvalinate: alpha-cyano-3-phenoxybenzyl N-(2-chloro-alpha, alpha, alpha, alpha-trifluoro-p-tolyl)-D-valinate,

Bifenthrin: (2-methylbiphenyl-3-ylmethyl)0(Z)-(1RS)-cis-3-(2-chloro-3,3,3-trifluoro-1-propenyl)-2,2-dimethylcyclopropanecarboxylate,

2-methyl-2-(4-bromodifluoromethoxyphenyl)propyl(3-phenoxybenzyl)ether,

Tralomethrin: (S)-alpha-cyano-3-phenoxybenzyl(1R-cis)3((1′RS)(1′, 2′, 2′, 2′-tetra-bromoethyl))-2,2-dimethylcyclopropanecarboxylate,

Silafluofen: 4-ethoxyphenyl(3-{4-fluoro-3-phenoxyphenyl)propyl}dimethylsilane,

D-fenothrin: 3-phenoxybenzyl(1R)-cis, trans)-chrysanthemate,

Cyphenothrin: (RS)-alpha-cyano-3-phenoxybenzyl(1R-cis, trans)-chrysanthemate, D-resmethrin: 5-benzyl-3-furylmethyl(1R-cis, trans)-chrysanthemate,

Acrinathrin: (S)-alpha-cyano-3-phenoxybenzyl(1R-cis(Z))-(2,2-dimethyl-3-(oxo-3-(1,1,1,3,3,3-hexafluoropropyloxy)propenyl(cyclopropanecarboxylate,

Cyfluthrin: (RS)-alpha-cyano-4-fluoro-3-phenoxybenzyl 3-(2,2-dichlorovinyl)-2,2-dimethylcyclopropanecarboxylate,

Tefluthrin: 2,3,5,6-tetrafluoro-4-methylbenzyl(1RS-cis(Z))-3-(2-chloro-3,3,3-trifluoro-prop-1-enyl)-2,2-dimethylcyclopropanecarboxylate,

Transfluthrin: 2,3,5,6-tetrafluorobenzyl(1R-trans)-3-(2,2-dichlorovinyl)-2,2-dimethyl-cyclopropanecarboxylate,

Tetramethrin: 3,4,5,6-tetrahydrophthalimidomethyl(1RS)-cis, trans-chrysanthemate,

Allethrin: (RS)-3-allyl-2-methyl-4-oxocyclopent-2-enyl(1RS)-cis, trans-chrysanthemate,

Prallethrin: (S)-2-methyl-4-oxo-3-(2-propynyl)cyclopent-2-enyl(1R)-cis, trans-chrysan-themate,

Empenthrin: (RS)-1-ethynyl-2-methyl-2-pentenyl(1R)-cis,trans-chrysanthemate,

Imiprothrin: 2,5-dioxo-3-(prop-2-ynyl)imidazolidin-1-ylmethyl(1R)-cis, trans-2,2-dimethyl-3-(2-methyl-1-propenyl)-cyclopropanecarboxylate,

D-flamethrin: 5-(2-propynyl)-furfuryl(1R)-cis, trans-chrysanthemate, and 5-(2-propynyl)furfuryl 2,2,3,3-tetramethylcyclopropanecarboxylate;

Pyriproxyfen: 4-phenoxyphenyl(RS)-2-(2-pyridyloxy)propyl ether;

pyrethrum;

d-d, trans-cyphenothrin: (RS)-α-cyano-3-phenoxybenzyl(1RS,3RS;1RS,3SR)-2,2-dimethyl-3-(2-methylprop-1-enyl)cyclopropanecarboxylate;

Lambda-cyhalothrine:

α-cyano-3-phenoxybenzyl-3-(2-chloro-3,3,3-trifluoroprop-1-enyl)-2,2-dimethylcyclo-propane carboxylate, as a 1:1 mixture of (Z)-(1R,3R), R-ester and (Z)-(1S,3S), S-ester.

Carbamate compounds such as

Alanycarb: S-methyl-N[[N-methyl-N-[N-benzyl-N(2-ethoxy-carbonylethyl)amino-thio]carbamoyl]thioacetimidate,

Bendiocarb: 2,2-dimethyl-1,3-benzodioxo1-4-yl-methylcarbamate),

Carbaryl(1-naphthyl N-methylcarbamate,

Isoprocarb: 2-(1-methylethyl)phenyl methylcarbamate,

Carbosulfan: 2,3 dihydro-2,2-dimethyl-7-benzofuranyl[(dibutylamino)thio]methyl-carbamate,

Fenoxycarb; Ethyl[2-(4-phenoxyphenoxy)ethyl]carbamate,

Indoxacarb: Methyl-7-chloro-22,3,4°,5-tetrahydro-2-[methoxycarbonyl(-4-trifluoro-methoxyphenyl)]

Propoxur: 2-isopropyloxyphenol methylcarbamate,

Pirimicarb: 2-dimethylamino-5,6-dimethyl-4-pyrimidinyl-dimethylcarbamate,

Thiodiocarb: Dimethyl N,N′(thiobis((methylimino)carbonoyloxy)bisethanimidiothioate).

Methomyl: S-methyl N-((methylcarbamoyl)oxy)thioacetamidate,

Ethiofencarb: 2-((ethylthio)methyl)phenyl methylcarbamate,

Fenothiocarb: S-(4-phenoxybutyl)-N,N-dimethyl thiocarbamate,

Cartap: S,S′-(2-5 dimethylamino)trimethylene)bis(thiocarbamate)hydrochloride,

Fenobucarb: 2-sec-butylphenylmethyl carbamate,

XMC: 3,5-dimethylphenyl-methyl carbamate,

Xylylcarb: 3,4-dimethylphenylmethylcarbamate;

organophosphorous compounds such as

Trichlorfon: Phosphoric acid, (2,2,2-trichloro-1-hydroxyethyl)-, dimethyl ester

Fenitrothion: O,O-dimethyl O-(4-nitro-m-tolyl)phosphorothioate,

Diazinon: O,O-diethyl-O-(2-isopropyl-6-methyl-4-pyrimidinyl)phosphorothioate,

Pyridaphenthion: O-(1,6-dihydro-6-oxo-1-phenylpyrazidin-3-yl)O,O-diethyl phosphorothioate,

Pirimiphos-Etyl: O,O-diethyl O-(2-(diethylamino)6-methyl-pyrimidinyl)phosphorothioate,

Pirimiphos-Methyl; O-[2-(diethylamino)-6-methyl-4 pyrimidinyl]O,O-dimethyl phosphorothioate,

Etrimphos: O-6-ethoxy-2-ethyl-pyrimidin-4-yl-O,O-dimethyl-phosphorothioate,

Fenthion: O,O-dimethyl-O-[-3-methyl-4-(methylthio)phenyl phosphorothioate,

Phoxim: 2-(diethoxyphosphinothoyloxyimino)-2-phenylacetonitrile,

Chlorpyrifos: O,O-diethyl-O-(3,5,6-trichloro-2-pyrinyl)phosphorothioate,

Chlorpyriphosmethyl: O,O-dimethyl O-(3,5,6-trichloro-2-pyridinyl)phosphorothioate,

Cyanophos: O,O-dimethyl O-(4 cyanophenyl)phosphorothioate,

Pyraclofos: (R,S)[4-chlorophenyl)-pyrazol-4-yl]-O-ethyl-S-n-propyl phosphorothioate,

Acephate: O,S-dimethyl acetylphosphoroamidothioate,

Azamethiphos: S-(6-chloro-2,3-dihydro-oxo-1,3-oxazolo[4,5-b]pyridine-3-ylmethyl phosphorothioate,

Malathion: O,O-dimethyl phosphorodithioate ester of diethyl mercaptosuccinate,

Temephos: (O,O′(thiodi-4-1-phenylene)O,O,O,O-tetramethyl phosphorodithioate,

Dimethoate: ((O,O-dimethyl S-(n-methylcarbamoylethyl)phosphorodithioate,

Formothion: S[2-formylmethylamino]-2-oxoethyl]-O,O-dimethyl phosphorodithioate,

Phenthoate: O,O-dimethyl S-(alpha-ethoxycarbonylbenzal)-phosphorodithioate;

lodofenphos: O-(2,5-dichloro-4-iodophenyl)-O,O-dimethyl-phosphorthioate.

Insecticides with a sterilising effect on adult mosquitoes such as

1-(alfa-(chloro-alpha-cyclopropylbenzylidenamino-oxy)-p-tolyl)-3-(2,6-difluorobenzoyl)urea,

Diflubenzuron: N-(((3,5-dichloro-4-(1,1,2,2-tetraflouroethoxy)phenylamino)carbonyl)2,6 difluoro benzamid,

Triflumuron: 2-Chloro-N-(((4-(trifluoromethoxy)phenyl)-amino-)carbonyl)benzamide, or

a triazin such as N-cyclopropyl-1,3,5-triazine-2,4,6-triamin; and

The repellent is preferably selected from N,N-Diethyl-meta-toluamide (DEET), N,N-diethylphenylacetamide (DEPA), 1-(3-cyclohexan-1-yl-carbonyl)-2-methylpiperine, (2-hydroxymethylcyclohexyl) acetic acid lactone, 2-ethyl-1,3-hexandiol, indalone, Methyl-neodecanamide (MNDA), a pyrethroid not used for insect control such as {(+/−)-3-allyl-2-methyl-4-oxocyclopent-2-(+)-enyl-(+)-trans-chrysantemate (Esbiothrin), a repellent derived from or identical with plant extracts like limonene, eugenol, (+)-Eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella), IR3535 (ethyl butylacetylaminopropionate), icaridin (1-piperidine-carboxylic acid 2-(2-hydroxyethyl)-1-methylpropylester).

Suitable fungicides are for example

Azoles such as Bitertanol, Bromoconazole, Cyproconazole, Difenoconazole, Dinitro-conazole, Epoxiconazole, Fenbuconazole, Fluquiconazole, Flusilazole, Flutriafol, Hexa-conazole, Imazalil, Ipconazole, Metconazole, Myclobutanil, Penconazole, Propiconazole, Prochloraz, Prothioconazole, Simeconazole, Tebuconazole Tetra-conazol, Triadimefon, Triadimenol, Triflumizol, Triticonazol; Strobilurines such as Azoxystrobin, Dimoxystrobin, Fluoxastrobin, Kresoxim-methyl, Metominostrobin, Orysastrobin, Picoxystrobin, Pyraclostrobin and Trifloxystrobin; Acylalanines such as Benalaxyl, Metalaxyl, Mefenoxam, Ofurace, Oxadixyl; Aminderivatives such as Aldimorph, Dodine, Dodemorph, Fenpropimorph, Fenpropidin, Guazatine, Iminoctadine, Spiroxamin, Tridemorph; Anilinopyrimidines such as Pyrimethanil, Mepanipyrim, Cyprodinil; Dicarboximide such as Iprodion, Myclozolin, Procymidon, Vinclozolin; Cinnamic amides and derivatives such as Dimethomorph, Flumetover, Flumorph; Antibiotics as Cycloheximide, Griseofulvin, Kasugamycin, Natamycin, Polyoxin, Streptomycine; Dithiocarbamates such as Ferbam, Nabam, Maneb, Mancozeb, Metam, Metiram, Propineb, Polycarbamat, Thiram, Ziram Zineb; Heterocyclic compounds such as Anilazin, Benomyl, Boscalid, Carbendazim, Carboxin, Oxycarboxin, Cyazofamid, Dazomet, Dithianon, Famoxadon, Fenamidon, Fenarimol, Fuberidazol, Flutolanil, Furametpyr, Isoprothiolan, Mepronil, Nuarimol, Picobenzamid, Probenazol, Proquinazid, Pyrifenox, Pyroquilon, Quinoxyfen, Silthiofam, Thiabendazol, Thifluzamid, Thiophanat-methyl, Tiadinil, Tricyclazol, Triforine M Anorganika; Nitrophenylderivatives such as Binapacryl, Dinocap, Dinobuton, Nitrophthal-isopropyl; Phenylpyrroles such as Fenpiclonil, Fludioxonil;

Derivatives of sulfenic acid such as Captafol, Captan, Dichlofluanid, Folpet, Tolylfluanid;

Other fungicides such as Acibenzolar-S-methyl, Benthiavalicarb, Carpropamid, Chlorothalonil, Cyflufenamid, Cymoxanil, Dazomet, Diclomezin, Diclocymet, Diclofluanid, Diethofencarb, Edifenphos, Ethaboxam, Fenhexamid, Fentin-Acetat, Fenoxanil, Ferimzone, Fluazinam, Fosetyl, Fosetyl-Aluminium, Phosphoric Acid,

Iprovalicarb, Hexachlorbenzene, Metrafenon, Pencycuron, Propamocarb, Phthalid, Toloclofos- methyl, Quintozene, Zoxamid.

Preferred insecticides and/or repellents of the pesticidal composition of the invention may be either one or a mixture. Preferred mixtures of pesticides are mixtures of insecticides and/or repellents with similar diffusion/migration properties. This group of insecticides and/or repellents may include synthetic pyrethroids such as alphacypermethrin, cyfluthrin, deltamethrin, etofenprox and permethrin, other pyrethroids such as bifenthrine, and non-pyrethroids such as chlorfenapyr.

Finishing

The term “finishing” means according to the invention any type of treatment of the net with the insecticide mixture, by means of which treatment a homogeneous distribution of the mixture on or in the net is achieved. In this context, homogeneous means that the concentration of a certain insecticide is essentially the same at any point of the areas.

In one embodiment, finishing is effected by coating the net or, preferably, monofilaments or multifilaments or fibers of which the net is produced with the insecticide mixture together with a binder (variant A).

In a further embodiment, finishing is effected by admixing the insecticide mixture to a polymer and coextruding the polymer and the insecticide mixture to give a monofilament which is processed to give the net according to the invention (variant B).

Finishing by Coating with an Insecticide-Mixture-Comprising Binder (Variant A)

The function of the binder is to fix the insecticide mixture on the monofilaments or multi-filaments or fibers of which the net is produced, or on the finished net (“end of line coating”) (hereinbelow described with reference to a net). The result achieved hereby is that the active compound cannot be leached, or at least only very slowly.

The polymeric binder may, in principle, take the form of any binder with the proviso that the binders are capable of fixing the insecticide mixture in particular to textile materials. Binders which are therefore preferred are those known from the field of textile finishing and textile coating. Naturally, it is also possible to employ a mixture of a plurality of different binders.

Examples comprise homo- or copolymers comprising (meth)acrylates, or polyurethanes, polyisocyanurates or waxes, such as polyethylene waxes.

For example, they may be binders which can be obtained by polymerization of ethylenically unsaturated monomers, preferably at least one monomer selected from the group consisting of (meth)acrylates, in particular C₁- to C₁₂-esters of (meth)acrylic acid, (meth)acrylates having crosslinking groups, (meth)acrylic acid, maleic acid or maleic esters, acrylonitrile, styrene, vinyl acetate, vinyl alcohol, ethylene, propylene, allyl alcohol or vinyl chloride.

In a preferred embodiment of the invention, this is a copolymer of ethylenically unsaturated monomers which comprises, as monomers, 50 to 95% by weight of at least one (meth)acrylate (A) of the general formula H₂C═CHR¹—COOR², where R¹ is H or methyl and R² is an aliphatic, linear or branched hydrocarbon radical having 1 to 12 carbon atoms, preferably 2 to 10 carbon atoms. R¹ is preferably H. Examples of suitable radicals R² comprise in particular methyl, ethyl, n-butyl or 2-ethylhexyl radicals, preferably ethyl, n-butyl or 2-ethylhexyl radicals. Moreover, the copolymer comprises 1 to 20% by weight of (meth)acrylic acid or (meth)acrylic acid derivatives (B) with additional functional groups. This may take the form in particular of a (meth)acrylic ester and/or (meth)acrylamides. The functional groups serve to bind the binder to the nets and can furthermore be used for crosslinking. For example, they may take the form of ω-hydroxyalkyl (meth)acrylic esters, (meth)acrylic esters having epoxy groups such as, for example, glycidyl esters, (meth)acrylamides or derivatives thereof such as, for example, (meth)acrylic acid methylolamide of the formula H₂C═CH(CH₃)—CO—HN—CH₂—OH. It is at the same time possible to employ further ethylenically unsaturated, preferably monoethylenically unsaturated, monomers (C) which differ from A and B, for example acrylonitrile or styrene. As a rule, the amount of further monomers is from 0 to 30% by weight. Especially preferred is a binder which comprises 70 to 90% by weight of an acrylic ester of the formula H₂C═CH₂ —COOR², where R² comprises 4 to 8 C atoms, and which is preferably n-butyl and/or 2-ethylhexyl, and furthermore 10 to 20% by weight of acrylonitrile, 1 to 10% by weight of (meth)acrylic acid or a (meth)acrylic acid derivative which has functional groups, in particular (meth)acrylic acid methylolamide.

The abovementioned preferred binders can preferably be prepared by methods known to the skilled worker, preferably by means of emulsion polymerization. Preferably an acrylate binder, in particular a copolymer, can be obtained by emulsion polymerization of the components B1 to B4, and optionally B5.

As component B1, one or more, preferably 1, 2 or 3, especially preferably 1, (meth)acrylate(s) of the formula (I)

H₂C═CR¹—COOR² (I)

is/are employed, where the symbols have the following meanings:
R¹ is H or CH₃, preferably H, and
R² is C₁-C₁₀-alkyl, preferably methyl, ethyl, n-propyl, i-propyl, n-butyl, i-butyl, sec-butyl, t-butyl, n-pentyl, sec-pentyl, neopentyl, 1,2-dimethylpropyl, i-amyl, n-hexyl, i-hexyl, n-heptyl, n-octyl, 2-ethylhexyl, n-nonyl or n-decyl, especially preferably methyl, ethyl, n-butyl or 2-ethylhexyl, very especially preferred are ethyl, n-butyl or 2-ethylhexyl.

Preferred as component B1 are methyl acrylate, ethyl acrylate, n-butyl acrylate, 2-ethylhexyl acrylate and methyl methacrylate. Also preferred are butyl acrylate on its own or in admixture with methyl methacrylate or ethyl acrylate. Especially preferred is n-butyl acrylate.

Substances which are employed as component B2 are at least one monomer from the group consisting of N-methylolacrylamide, N-methylolmethacrylamide, N,N′-bis-methylolmaleic diamide and N,N′-bismethylolfumaric diamide.

Preferred are N-methylolacrylamide and N-methylolmethacrylamide, in particular N-methylolmethacrylamide.

Substances which are employed as component B3 are one or more monomers, preferably one or two monomers selected from the group consisting of acrylic acid, meth-acrylic acid, vinylsulfonic acid, maleic acid and fumaric acid. Preferred are acrylic acid and methacrylic acid; acrylic acid is especially preferred.

Substances which are employed as component B4 are one or more monomers, preferably one or two monomers, selected from groups B4A and/or B4B.

Monomers of group B4A are those of the formula (II) and/or (III)

H₂C═CR³X (II)

ZHC═CHZ (III)

where the symbols have the following meanings:
R³ is H or CH₃, preferably H;
X is Z, —CO—NH—CH₂—NH—CO—CR³═CH₂ or
   COO—CH₂—CO—CH₂—COOR⁴, preferably Z;
Z equals CONH₂, CONH—CH₂—OR⁵, COO—Y—OH, COO-glycidyl, CHO, CO—Y—OH, preferably CONH₂;
Y is C₁-C₈-alkylene, preferably C₂-C₆-alkylene, and
   R⁴, R⁵ are identical or different and are a linear or branched C₁-C₁₀-alkyl group;
   and (meth)acrylic-modified benzophenones, as described, for example, in EP-A 0 346 734.

Preferred as monomers from group B4A are acetoacetyl acrylate, acetoacetyl methacrylate, acrylamide, methacrylamide, maleic diamide, N-methoxymethylacrylamide, N-n-butoxymethylacrylamide, 3-hydroxypropyl acrylate, 3-hydroxypropyl methacrylate, 4-hydroxybutyl acrylate, 4-hydroxybutyl methacrylate, 6-hydroxyhexyl acrylate, 6-hydroxyhexyl methacrylate, 2-hydroxy-3-chloropropyl acrylate, 3-hydroxy-3-chloropropyl methacrylate, glycidyl acrylate and glycidyl methacrylate. Especially preferred are acrylamide, 3-hydyroxypropyl methacrylate, butanediol monoacrylate acetylacetate, glycidyl methacrylate, and 4-acryloxybenzophenone.

Substances which are employed as monomers from group B4B are allyl acrylate, methallyl acrylate, allyl methacrylate, methallyl methacrylate, diallyl maleate, dimethylallyl maleate, allyl fumarate, methallyl fumarate, diallyl phthalate, dimethylallyl phthalate, diallyl terephthalate, dimethallyl terephthalate, p-divinylbenzene, butane-1,4-diol diallyl ether and butane-1,4-diol dimethylallyl ether.

Preferred monomers of group B4 are those of group B4A, the use of one or two monomers from among this group being preferred.

Preferred monomers of group B5 are those of group B5A, and also vinylaromatic monomers of group B5B.

It is preferred to employ acrylonitrile or methacrylonitrile, preferably acrylonitrile, as component B5A.

Preferred as component B5B are styrene and a-methylstyrene, styrene being especially preferred.

In a preferred embodiment, acrylonitrile is employed as monomer of component B5 for the preparation of the acrylate binder.

The acrylate binder (B) is obtainable by emulsion polymerization of (data in % by weight are in each case based on the total amount of B):
b1) 20 to 93% by weight, preferably 50 to 90% by weight, especially preferably 60 to 90% by weight, in particular 75 to 85% by weight, of component B1;
b2) 1 to 5% by weight, preferably 1.5 to 3% by weight of component B2;
b3) 0.2 to 5% by weight, preferably 0.5 to 4% by weight, especially preferably 0.75 to 4% by weight, in particular 1 to 3% by weight of component B3;
b4) 0 to 7% by weight, preferably 0 to 5% by weight, especially preferably 0 to 4.5% by weight, in particular 0 or 0.2 to 4.5% by weight of component B4 and
b5) 0 to 40% by weight, preferably 5 to 40% by weight, especially preferably 5 to 30% by weight, in particular 0 or 5 to 26% by weight of component B5.

Suitable processes are known to the skilled worker and described, for example, in WO 2005/064072 (page 20, line 20 to page 23, line 15).

The weight-average molecular weight of the non-crosslinked emulsion polymers obtained is generally between 40 000 and 250 000 (as determined by GPC (gel permeation chromatography)). The molecular weight is generally adjusted by using chain termination reagents, for example organosulfur compounds, in the usual amounts. The especially preferred acrylate binder is generally obtained in the form of an aqueous dispersion and is usually employed in this form in the insecticidal formulation according to the invention.

The preferred acrylate binder can furthermore comprise usual additives known to the skilled worker, for example film formers and/or plasticizers, such as adipates, phthalates, butyl diglycol, mixtures of diesters, obtainable by reacting dicarboxylic acids with straight-chain or branched alcohols. Suitable dicarboxylic acids and alcohols are known to the skilled worker.

Others which are suitable, apart from the abovementioned binders, are silicone oils and silicone waxes, polysiloxanes, resins with fluorinated hydrocarbon radicals, melamine/formaldehyde condensates, methylolurea derivatives and curable polyesters, with silicone oils being preferred.

The preferred silicone oils and silicone waxes generally take the form of linear or cyclic polyorganosiloxanes, preferably polyalkyl- and/or polyphenylsiloxanes, alkyl being for example methyl, ethyl, propyl or octyl, preferably methyl. Particularly preferred are polydimethylsiloxanes, poly(methylphenylsiloxanes) and corresponding compounds in which a proportion of the methyl groups is replaced by higher alkyl groups. The molecular weight is preferably between 1000 and 150 000. If appropriate, the silicone oils and in particular the silicone waxes may comprise consistency regulators, for example metal soaps such as lithium stearate, highly-disperse silica, PTFE, boron nitride or urea, in order to obtain a pasty or fatty consistency.

To prepare the nets according to the invention, in particular nets, the binders may be employed in the form of a formulation in a solvent, preferably as an aqueous formulation. However, the invention also comprises the use of solvent-free formulations.

In a preferred embodiment, aqueous formulations are employed which comprise 55 to 99% by weight of water, preferably 85 to 98% by weight of water and 1 to 45% by weight, preferably 2 to 15% by weight, of solids, the quantities given being in each case based on the total of all components in the formulation. The precise concentration also depends on the adsorptivity of the textile substrate.

The solids take the form of at least one binder, the insecticidal mixture, optionally at least one crosslinker and optionally further components.

It is preferred to employ at least one water-dispersible crosslinker. In particular in the case of the preferred acrylate binder, this may preferably take the form of a crosslinker which has free isocyanate groups. These may preferably take the form of isocyanurates which have free isocyanate groups, preferably isocyanurates which are derived from aliphatic, cycloaliphatic or aromatic diisocyanates having 4 to 12 carbon atoms. Examples comprise 1,6-hexamethylene diisocyanate, 1,12-dodecane diisocyanate, 2,2′- and 2,4′-dicyclohexylmethane diisocyanate or 2,4-tolyl diisocyanate. Preferred are isocyanurates based on 1,6-hexamethylene diisocyanate. Especially preferred are isocyanurates which have additional hydrophilic groups such as, in particular, polyethylene oxide groups. The preparation of such isocyanurates is known to the skilled worker. They are preferably employed as a solution in polar aprotic solvents such as, for example, ethylene carbonate or propylene carbonate. Further details on the preferred crosslinkers having isocyanate groups are disclosed in WO 2008/052913 page 34, line 6 to page 35, line 3. It is especially preferred to employ an isocyanurate which is based on 1,6-hexamethylene diisocyanate (HMDI) and which has additional polyethylene oxide groups, the isocyanurate being dissolved in propylene carbonate (70% by weight of HMDI in propylene carbonate). The free isocyanate groups amount to approximately 11 to 12% by weight based on the solution. The crosslinker is preferably employed in an amount of from 1 to 10% by weight based on the amount of all solids of the formulation. The isocyanurate-based crosslinkers are suitable especially for crosslinking the above-named copolymers.

The formulation may furthermore comprise typical additives and adjuvants, UV stabilizers and colorants. Examples of such additives are mentioned in WO 2008/052913 page 35, line 17 to page 37, line 5.

Crosslinkers and thickeners may be employed to enable uniform coating with the treatment liquor of nets which can only be wetted with difficulty, and therefore inhomogeneously, such as, for example, polyolefin fibers. For this purpose, it would also be possible to employ water-miscible solvents, which, however, is not preferred due to the harmful effect on the environment. A person skilled in the art is familiar with the adjuvants which are conventionally used and with their concentrations.

The formulations may preferably comprise antioxidants, peroxide scavengers, UV absorbers and light stabilizers. This is particularly recommended in the case of nets which are exposed to increased UV irradiation in the open or in greenhouses. The abovementioned additives protect not only the substrate fibers, but also the active compounds, from decomposition due to radiation.

Suitable UV absorbers are described for example in WO 02/46503 or in WO 2007/077101. UV absorbers may firstly be used as a component in the formulation for finishing; secondly, they may also be incorporated as early as during the production of the fibers, for example in the case of polyolefins and polyesters. It is also possible advantageously to employ mixtures of a plurality of stabilizers which have different protective effects. As a rule, from 0.2 to 5% by weight, preferably from 0.25 to 4% and very especially preferably from 0.5 to 3.5% by weight of stabilizer is employed based on the weight of the untreated net. The amount in the formulation will be adjusted by the skilled worker to suit the task in hand.

Finishing According to Variant B by Incorporating the Insecticide Mixture into Monofilaments

In a further embodiment of the invention, finishing is carried out by directly incorporating the mixture according to the invention into a monofilament which is processed for example to give fibers, of which the net according to the invention consists or which are present therein, Preferably, the net in this variant is a net.

A suitable polymer material for the monofilament into which the mixture according to the invention can be incorporated are thermo plastic polymers, preferably those based on olefinically unsaturated monomers, for example polyolefins, polyvinyl chloride, polyvinyl alcohols, poly(meth)acrylates, but also polyesters and polycarbontes, and, if appropriate, mixtures of the abovementioned polymers with each other or with thermoplastic elastomers. Especially preferred are polyethylene, for example low-density polyethylene (LDPE), such as linear low-density polyethylene (LLDPE), ultra-low density polyethylene (ULDPE), medium-density polyethylene (MDPE) and high-density polyethylene (HDPE), polyethylene resins such as copolymers of ethylene and alphaolefins with at least three carbon atoms, polypropylene homopolymers, random copolymers and block copolymers of propylene and alpha-olefins with four and more carbon atoms, copolymers of ethylene with unsaturated carboxylic acid compounds, for example poly(ethylene/methyl methacrylate), poly(ethylene/vinyl acetate) or poly(ethylene/acrylic acid), and mixtures of such polymers and copolymers. Examples of thermoplastic elastomers comprise olefin- and styrene-based thermoplastic elastomers. Preferred are copolymers with ethylene or propylene as the main component, but also block copolymers comprising polystyrene and polyisoprene and/or polybutadiene blocks, and hydrogenated derivatives of such copolymers.

To produce the monofilaments which comprise the insecticide mixture according to the invention in a thermoplastic polymer matrix, the insecticide mixture and the polymer may be mixed by melt-kneading. It is also possible first to prepare a masterbatch by melt-kneading suitable amounts of insecticide mixture and polymer, which masterbatch is subsequently diluted to the desired concentration by melt-kneading with a further quantity of polymer. If the masterbatch method is employed, it is also possible to use different polymers for the masterbatch and for the subsequent dilution, for example an LLDPE for the masterbatch and an HDPE for diluting the masterbatch.

Besides the polymer and the insecticide mixture according to the invention, the polymer composition comprises, if appropriate, a pulverulent carrier material, preferably from the group of the talcs, kaolin, loams, finely-pulverulent SiO₂, carbon and dextrins. The pulverulent carrier material, if present, amounts to preferably from 0.01 to 10% by weight. The pulverulent carrier material can be mixed with the insecticide mixture and the polymer by melt-kneading, but it is preferred first to mix the insecticide mixture and the pulverulent material and subsequently to mix this mixture with the polymer, for example by melt-kneading. It is especially preferred to use a mixture of the pulverulent material and the insecticide mixture for preparing a masterbatch.

Besides polymer, insecticide mixture and, if appropriate, pulverulent carrier, the polymer composition comprises, if appropriate, customary additives to thermoplastic molding compositions, such as pigments, antioxidants, lubricants and the like.

To produce the filaments according to these embodiments of the invention, a mixture is prepared of, for example, polymer, insecticide mixture and, if appropriate, further additives by melt-kneading, preferably at elevated temperatures, the mixture is extruded and the extrudate is processed to give pellets. Such pellets can be drawn by meltspinning, by the extrusion method, to give a filament from which nets according to the invention can be woven, for example by the Raschel method.

Details on netting material and its production for this embodiment of the invention are described for example in WO 2008/004711.

Net

Examples of suitable nets are textile materials, nontextile plastic materials, paper, leather, man-made leather, films and other, preferably flexible, materials.

The net employed preferably takes the form of a textile material. They can take the form of nets made of natural fibers or synthetic fibers. Of course, they can also take the form of mixtures of two or more different fibers. Examples of natural fibers comprise cotton fibers, jute fibers or linen fibers. Preferably, they take the form of synthetic fibers made of suitable polymers. Examples comprise polyamides, polyesters, polyacrylonitrile or polyolefins. Preferably, they take the form of polyamides, polyolefins and polyesters, especially preferably polyolefins, in particular polypropylene or polyethylene, and polyesters. Very especially preferred are polyester fibers, in particular polyethylene terephthalate (PET).

The fibers may take the form of monofilaments, oligofilaments or multifilaments, which may be smooth or textured.

Polypropylene and polyethylene may take the form of polypropylene or polyethylene homopolymers. However, they may also take the form of copolymers, which comprise small amounts of other comonomers in addition to the ethylene or propylene. Suitable comonomers may take the form of, in particular, other olefins such as, for example, ethylene or propylene and but-1-ene, but-2-ene, isobutene, pent-1-ene, hex-1-ene, hept-1-ene, oct-1-ene, styrene or a-methylstyrene, dienes and/or polyenes. In general, the comonomers in the polyethylene or polypropylene amount to no more than 20% by weight, preferably no more than 10% by weight. The nature and amount of the comonomers are selected by the skilled worker as a function of the desired fiber properties.

Products which are especially preferred for the production of fibers are relatively high-molecular-weight, viscous products which are characterized in the customary manner by their melt flow index (determined as specified in ISO 1133). Preferably, they may take the form of at least one polypropylene or polyethylene with a melt flow index MFR (230° C., 2.16 kg) of from 0.1 to 60 g/10 min. Preferably, they take the form of polypropylene with a melt flow index MFR (230° C., 2.16 kg) of from 1 to 50 g/10 min, especially preferably from 10 to 45 g/10 min and for example 30 to 40 g/10 min. Such types of polypropylene are particularly suitable for the production of fibers. Of course, a mixture of a plurality of different types of polypropylene may also be employed.

Depending on the nature of the net, the textile fibers have a thickness of from 0.05 to 0.6 mm, preferably 0.1 mm to 0.4 mm, especially preferably 0.12 to 0.35 mm and very especially preferably 0.2 to 0.3 mm.

The nets preferably have a mesh pattern with an even number of corners. In this context, the nets may consist preferably of a simple type of mesh only, for example of quadrangular meshes only or of hexagonal meshes only, or else they may also comprise two or more types of different meshes, for example a combination of octagonal and quadrangular meshes.

In this context, the meshes of the net should preferably be essentially of the same type, i.e. while the net may indeed feature minor deviations in respect of shape and size of the meshes, the values will not vary unduly around the means.

Suitable mesh sizes (length of the side of a square mesh) are in the range of 5 mm, preferably 2.5 mm, in particular 1.5 mm as the upper limit and 0.1 mm, preferably 0.25 mm, especially preferably 0.5 mm, in particular 0.7 mm as the lower limit.

The meshes of the net are preferably selected from the group of quadrangular, hexagonal or octagonal meshes.

The quadrangular meshes take the form of meshes in the shape of a parallelogram with the sides a and b. Naturally, the term “parallelogram” also comprises the terms “rectangle” and “square”. The smaller angle between the two sides of the parallelogram will, as a rule, be between 60 and 90°. In the borderline case of 90°, the parallelogram takes the form of a rectangle. In the borderline case a=b and 90°, it takes the form of a square. The parallelogram furthermore has a height hₐ. In the case of a rectangle or a square, the height hₐ corresponds to the length of side a. Square meshes are particularly preferred.

In the case of the hexagonal meshes, three pairs of sides a, b and c, which run in each case parallel to each other, are arranged at the distances hₐ, h_{b} and h_{c}. In the case of the octagonal meshes, four pairs of sides a, b, c and d, which run in each case parallel to each other, are arranged at the distances hₐ, h_{b}, h_{c} and h_{d}. A person skilled in the art knows that no continuous patterns can be established with octagons. A net which comprises octagonal meshes will, therefore, additionally comprise at least one second type of mesh. These may take the form of quadrangular meshes.

In a specific embodiment of the invention, the height hₐ in the parallelogram, the hexagon and the octagon is from 0.1 to 0.99 mm, preferably from 0.1 to 0.9 mm, especially preferably from 0.12 to 0.8 mm and very especially preferably from 0.25 to 0.7 mm.

In the parallelogram, the length-to-height ratio b/hₐ is from 1:1 to 5:1, preferably from 1:1 to 4:1 and especially preferably from 2:1 to 4:1. Therefore, in the case of a ratio b/hₐ of 1:1, the meshes may take the form of a square with a side length of from 0.1 to 0.99 mm. In the case of a wider ratio of b/hₐ, they take the form of a structure which is elongated along one axis. By virtue of the distance hₐ of no more than 0.99 mm, even smaller insects are efficiently prevented from passing across the net, while the length can indeed be greater than 0.99 mm, so that the air permeability of the net is not unduly hindered.

In the case of a hexagon, the ratio ((h_{b}+h_{c})/2)/hₐ is from 1:1 to 5:1, preferably from 1:1 to 4:1 and especially preferably from 2:1 to 4:1. Here, the situation is analogous to the parallelogram. A ratio of 1:1 will result in a regular hexagon with three equal sides, each of which have an equal distance of no more than 0.99 mm to each other. A greater ratio ((h_{b}+h_{c})/2)/hₐ results in a hexagon which is elongated along one axis. The effect regarding permeability to insects and air is as in the case of the parallelogram.

In the case of an octagon, the ratio ((h_{b}+h_{c}+h_{d})/3)/hₐ is from 1:1 to 5:1, preferably from 1:1 to 4:1 and especially preferably from 2:1 to 4:1. Here, the ratios are analogous to the parallelogram. A ratio of 1:1 will result in a regular octagon with four equal sides, each of which have an equal distance of no more than 0.99 mm to each other. A greater ratio ((h_{b}+h_{c}+h_{d})/3)/hₐ results in an octagon which is elongated along one axis. The effect regarding permeability to insects and air is as in the case of the parallelogram.

Besides quadrangular and hexagonal meshes, it is also possible, for example, to employ combinations of quadrangular and octagonal meshes in this embodiment, or to vary the shape and size of the meshes in parts of the net. For example, the edges of the net can be knitted more densely, or else thicker textile fibers, which are also made of a different polymer, may be knitted in at certain distances in order to stabilize the net.

The terms “height” and “length” refer to the open area of each mesh without taking into consideration the fibers or the coated fibers. Analogously, the term “mesh size” for the purposes of the present invention means the hole size of the meshes, i.e. the open area of each mesh without taking into consideration the fibers or the coated fibers.

Textile net materials according to this embodiment of the invention are described in European Patent Application 08 161 456.

The thickness of the fibers used for the production of the textile material according to the invention, in particular of the nets according to the invention, is selected by the skilled worker depending on the desired properties of the net. As a rule, the thicker the fibers, the greater the mechanical stability of the net; on the other hand, the proportion of open area in comparison with the proportion of the fiber-covered area will decrease with decreasing mesh size. As a rule, the fiber thickness should be such that the open area of the net will be at least 20%, preferably at least 40% and in particular at least 50% of the net. Nets of the abovementioned type are commercially available.

The nets used can preferably take the form of single-layer nets. However, they may also take the form of what are known as spacer fabrics, where two nets are connected to one another with the aid of individual yarns to form a double layer.

The protective construction according to the invention is useful for any kind of stored goods susceptible to pest infestation, like food and other products obtained from plants, such as coffee, dried fruits, cocoa, nuts, tea, cereals, vegetables and spices. In a preferred embodiment it is used for protecting tobacco, tobacco bales or other tobacco products. It can be used for protecting any kind of tobacco, such as e.g. tobacco produced from Nicotiana rostica and Nicotiana tabacum, specifically dark tobacco, bright tobacco, burley tobacco, shade tobacco and Perique.

The construction is useful for protecting the tobacco from any kind of pests and disease encountered in the transport and storage of tobacco, specifically from storage pests, like bugs, beetles,moths and mites.

Such pests include:

Cigarette beetle (Lasioderma serricorne), tobacco moth (Ephespha elutella), confused flour beetle (Tribolium confusum), red flour beetle (Tribolium castaneum), saw-toothed grain beetle (Oryzaephilus surinamensis), yellow meal worm (Tenebrio molitor), lesser meal worm (Alphitobius diaperinus), granary weevil (Sitophilus granarius), lesser grain borer (Rhyzopertha dominica), maize weevil (Sitophilus zeamais), rice weevil (Sitophilus oryzae), angoumois grain moth (Sitotroga cerealella), Indian meal moth (Plodia interpunctella), drugstore beetle (Stegobium paniceum), cadelle beetle (Tenebroides mauritanicus), longheaded flour beetle (Latheticus orizae), dark mealworm (Tenebrio obscurus), dermestid beetles such as: black carpet beetle, larder beetle, wardrobe beetle, odd beetle, hide beetle, warehouse beetle, spider beetles, weevils, especially the bean weevil, grain mite, black flour beetle, flat grain beetles, fruit flies, vinegar flies, rusty grain beetle, hairy fungus beetle, flat grain beetle, sap beetles, deathwatch beeties, darkling beetles, and fungus beetles.

The system according to the invention is specifically useful for the control of the cigarette beetle (Lasioderma serricorne), and the tobacco moth (Ephespha elutella), the two main pests in tobacco storage.

In a further embodiment the system of the invention is used for the transport of animals, specifically warmblooded animals, e.g. companion animals, such as cats and dogs, horses and productive livestock, such as cattle, pigs and sheep.

In another embodiment the system of the invention is used for the transport of crop plants and ornamental plants.

In these cases the protected goods are animals and/or plants.

Employing the system of the invention in the transport of animals could be useful, e.g. in avoiding or shortening quarantine for the animals.

The invention is further illustrated by the following examples without limiting it thereby.

### EXAMPLES

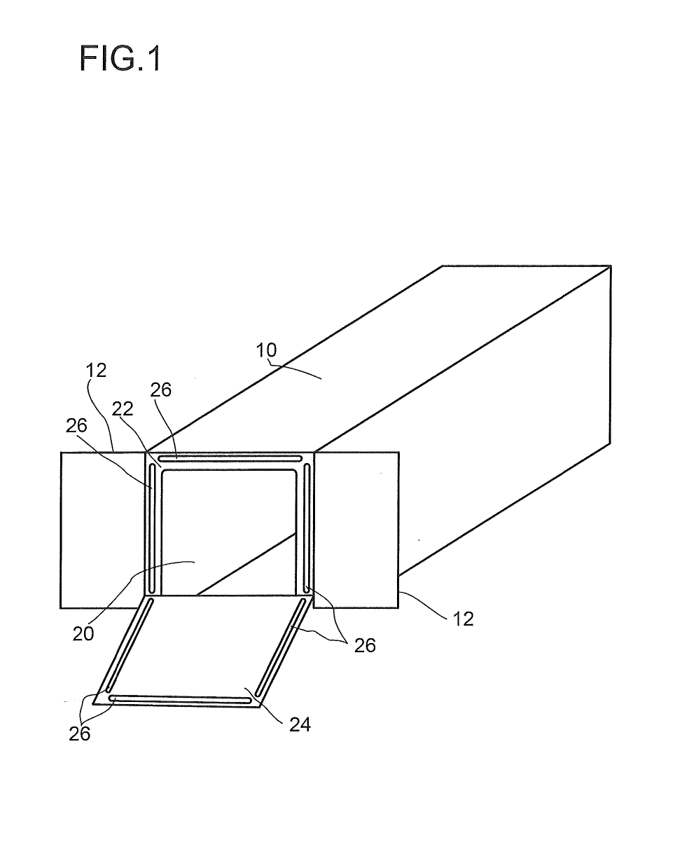

In FIG. 1 a container 10 in perspective view is shown. The doors 12 of the container allow access to the interior. A three dimensional net 22 is used to line the walls of the container 10 and forms a cage-like structure 20 inside the container 10. The front section 24 of the net 22 is constructed so that it can be quickly removed to open the cage-like structure 20, Velcro strips 26 on the front section 24 and the main section of the net 22 allow the re-attachment of the front section 24 to close the cage-like structure 20.

In the embodiment shown in FIG. 1 the front section 24 of the net 22 opens towards the bottom and is constructed to bear a fork lift so that access to the container 10 by a fork lift is not hindered.

In a further embodiment of the invention the front section 24 can be completely detached from the cage like structure 20 to allow easy access to the inside of the container 10.

In another embodiment of the invention the front section 24 comprises adhesives to attach the front section 24 to the main section of the net 22.

In further embodiments of the invention different means to remove and re-attach the front section 24 to the main section of the net 22 are provided. Suitable means comprise zippers, cables/ropes/chains, straps and/or rubber bands.

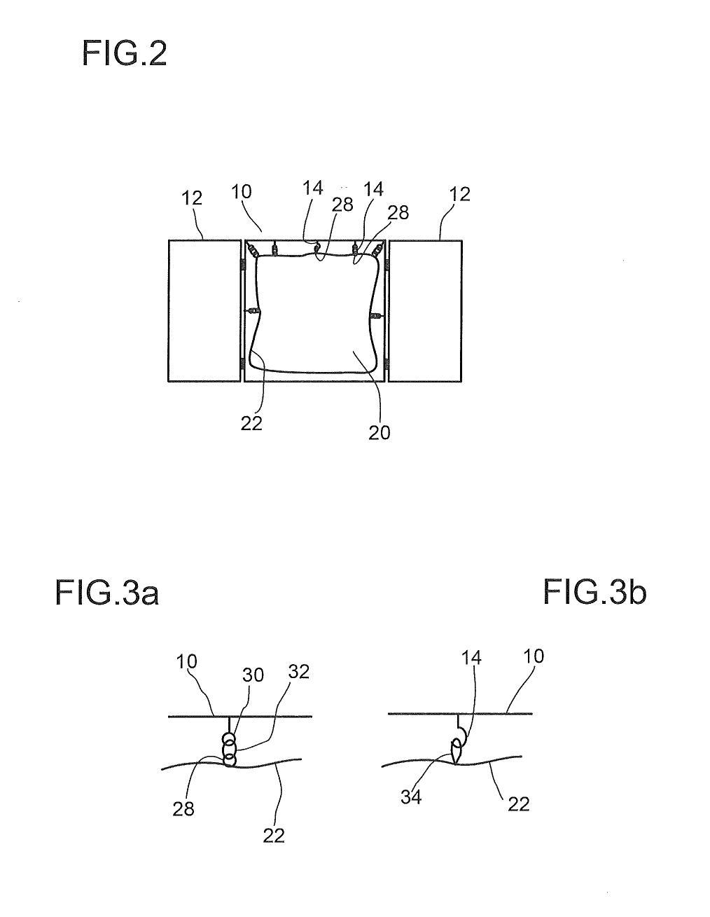

FIG. 2 shows the front side of a container 10 with opened doors 12. The cage-like structure 20 is fixed to the container 10 using means to suspend the cage-like structure. In the shown embodiment these means comprise grommets 28 provided in the net 22 and hooks 14 arranged in the ceiling and/or the walls of the container 10. The front section 24 of the net 22 can be attached using any of the means described above.

FIG. 3a shows a further embodiment of the means to suspend the cage-like structure. The container 10 provides rings 30 and grommets 28 are arranged on the net 22. The net 22 can then be attached to the container 10 using cable ties 32 to connecting the grommets 28 to the rings 30. Wires, ropes and or straps can also be used instead of cable ties 32

FIG. 3b shows a further embodiment of the means to suspend the cage-like structure. The container 10 provides hooks 14 to receive straps 34 which are arranged on the net 22.

1. A system for protecting stored goods in a container, comprising a cage-like structure formed by at least one pesticide treated net, capable of enclosing the stored goods,
wherein the cage like structure further comprises,
means for suspending the pesticide treated nets, and
means for opening and closing the cage-like structure on at least one section of the at least one net.

2. The system of claim 1, wherein the means for suspending the at least one pesticide treated net comprise straps, rings, hooks, clamps, cable ties, cables/ropes/chains, rubber bands and/or grommets.

3. The system of claim 1 wherein, the means for opening and closing the cage-like structure comprise zippers, Velcro strips, adhesives, cables/ropes/chains, grommets, straps and/or rubber bands.

4. The system of claim 1, wherein the cage-like structure is formed by a single three dimensional net.

5. The system of claim 1 wherein the system further comprises means to monitor pest levels.

6. The system of claim 5, wherein the means to monitor pest levels comprises pheromone traps inside and/or outside the cage like structure.

7. The system of claim 1, where the container is the loading area of a vehicle.

8. The system of claim 1, wherein the container is an ISO container.

9. A method for protecting goods during transport in a container, comprising the steps of installing a system according to claim 1 in the container and placing the goods inside the cage-like structure.

10. The method of claim 9 wherein the system for protecting stored goods comprises means to monitor pest levels.

11. The method of claim 10, wherein the container is fumigated if the observed pest levels are above a predetermined threshold.

12. The method of claim 9, where the goods are selected from tobacco, coffee, dried fruits, cocoa, nuts, tea, cereals, vegetables and spices.

13. The method of claim 9, where the goods are animals.
